(19) United States
(12) Patent Application Publication
(10) Pub. No.: US 2019/0110432 A1
(43) Pub. Date: Apr. 18, 2019

(54) WATERPROOF AND BREATHABLE PET CUSHION

(71) Applicant: SHIH-YUN CHEN, Taipei City (TW)

(72) Inventor: SHIH-YUN CHEN, Taipei City (TW)

(21) Appl. No.: 15/784,207

(22) Filed: Oct. 16, 2017

(51) Int. Cl. A01K 1/035

(52) U.S. Cl. CPC A01K 1/0353

(57) ABSTRACT

A waterproof and breathable pet cushion includes a core containing filler; an outer cover covering outer sides of the core; the outer cover containing a surface cloth layer and a waterproof and breathable layer at an inner side of the surface cloth layer. The waterproof and breathable layer is made of polyurethane. The waterproof and breathable layer has the advantages of waterproof, breathability, burn-proof, insects-proof. As a result, the dirt of pets or fluid will not enter into the waterproof and breathable layer so as to retain the cleanness of an interior of the pet cushions; and in cleaning, it only needs to clean the outer cover.

### FIELD OF INVENTION

The present invention relates to cushions, and in particular to a waterproof and breathable pet cushion.

### BACKGROUND OF INVENTION

Cushions are frequently used in daily life. Recently, cushions are also used for pets. Materials, sizes, hardness of the cushions will affect the function thereof. Conventional cushions include a core and a mask enclosing the core.

Conventionally, cushions are made of cloth without functions of waterproof, breathability, fireproof, anti-mite, anti-mildew and other functions. However, generally, pets are bad in sanitation so that pet cushions are easily dirty. Therefore, they must be cleaned frequently. The conventional pet used cushions have no functions of waterproof, breathability, fireproof, anti-mite, anti-mildew and other functions so that the whole cushions will become dirty both in the core and outer covers, but generally, it is very difficult to clean the inner core of the cushions.

### SUMMARY OF THE INVENTION

To improve above defects in the prior art, the present invention provides a waterproof and breathable pet cushion, in that the cushion of the present invention is especially suitable for pets which are bad in sanitation, while the conventional pet cushions have no functions of waterproof, breathability, fireproof, anti-mite, anti-mildew and other functions, but the cushions of the present invention provides such functions.

To achieve above object, the present invention provides a waterproof and breathable pet cushion, comprising: a core containing filler; an outer cover covering outer sides of the core; the outer cover containing a surface cloth layer and a waterproof and breathable layer at an inner side of the surface cloth layer; the waterproof and breathable layer being made of polyurethane; wherein the waterproof and breathable layer has the advantages of waterproof, breathability, burn-proof, insects-proof; as a result, the dirt of pets or fluid will not enter into the waterproof and breathable layer so as to retain the cleanness of an interior of the pet cushions; and in cleaning, it only needs to clean the outer cover.

### BRIEF DESCRIPTION OF THE DRAWINGS

FIG. 1 is an assemble schematic view of the present invention.

FIG. 2 is a schematic view showing the core of the present invention.

FIG. 3 is another schematic view showing the core of the present invention.

FIG. 4 is a schematic view showing that the opening of the enclosure is opened.

FIG. 5 is a schematic view about the cover of the present invention.

FIG. 6 is a schematic view showing an operation for placing the core from the cover opening into the interior of the cover.

### DETAILED DESCRIPTION OF THE INVENTION

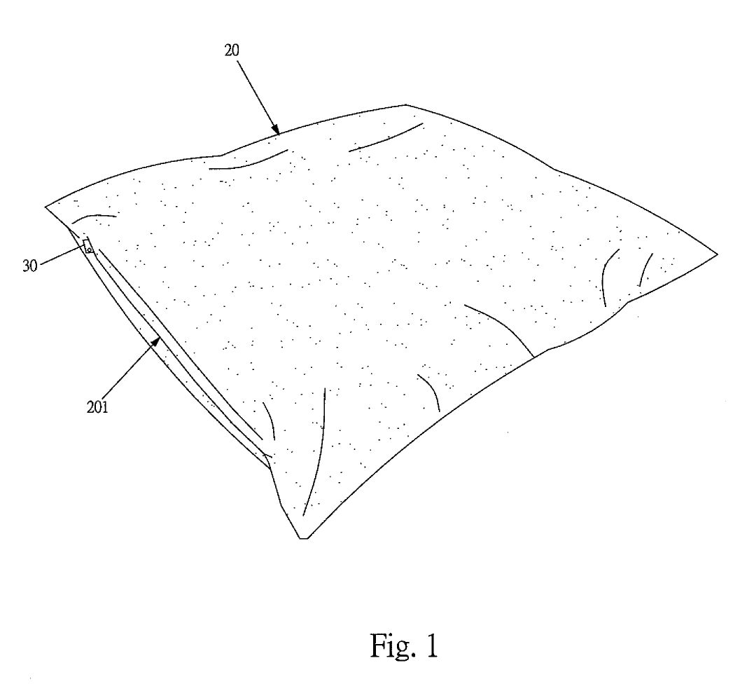

With reference to FIGS. 1 to 6, the water proof and breathable pet cushion is illustrated. The pet cushion of the present invention is suitable for home pets. It contains the following elements.

A core 10 contains filler 12 which are soft materials, preferably, cotton, sponge, cloth, etc., or plant filling materials, such as [symbol] petals, straws, activated carbons.

The cushion may have different shapes, such as rectangular shapes, round shape, etc., and may have different functions, such as a seat cushion, a back cushion, a pillow, an embracing pillow, etc. These are known in the prior art and thus the details will not be further described herein.

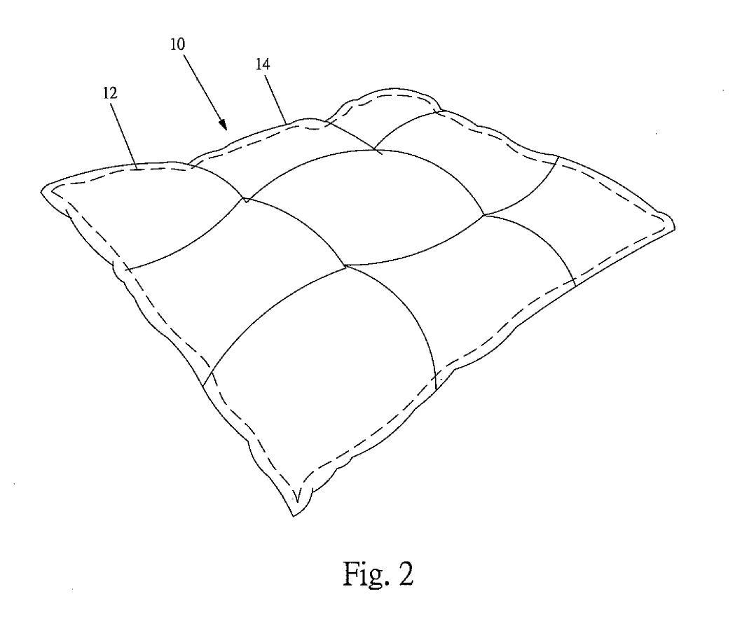

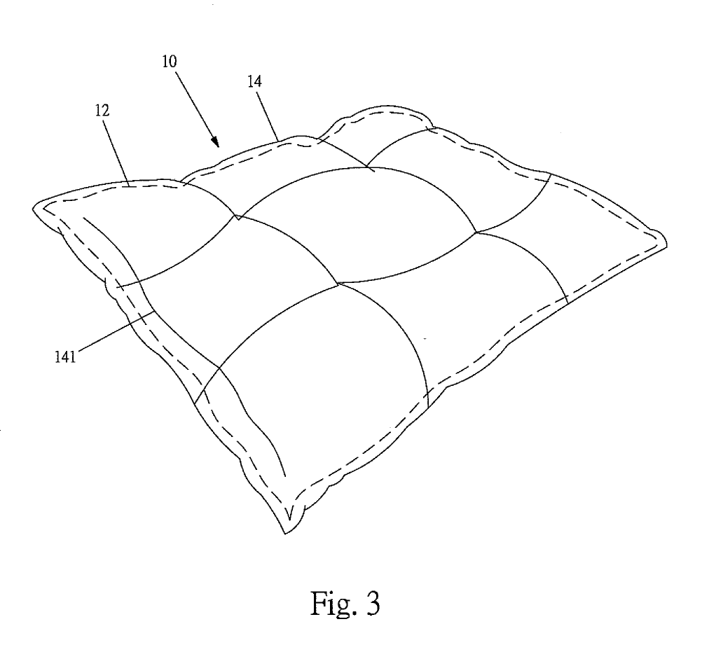

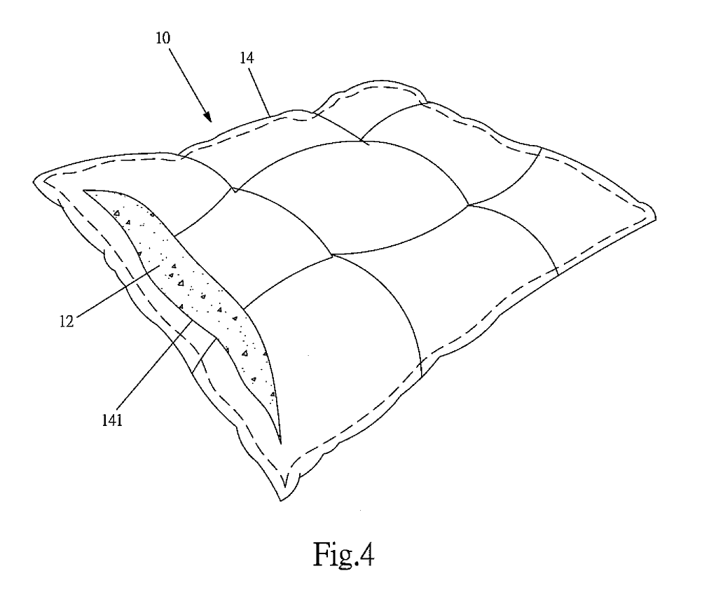

The core 10 further includes an inner cover 14 enclosing the filler 12. The inner cover 14 may completely enclose the filler 14, as illustrated in FIG. 2, or the inner cover 14 has an inner opening 141 (referring to FIG. 3). The filler 12 can be taken out from the inner opening 141 (referring to FIG. 4)

An outer cover 20 covers outer sides of the core 20. The outer cover 20 contains a surface cloth layer 22 and a waterproof and breathable layer 24. Preferably, the surface cloth layer 22 is made of polyester fiber and the waterproof and breathable layer 24 is made of polyurethane. Preferably, the waterproof and air permeable layer 24 is adhered to an inner side of the surface cloth layer 22 by gluing or adhesive materials which are known in the prior art and the thus the detailed will not be further described herein. FIG. 1 is an assembly view showing that the outer cover 20 covers the outer sides of the core 10.

The waterproof and breathable layer 24 has the advantages of waterproof, breathability, burn-proof, insects-proof, and other functions. As a result, the dirt of pets or fluid will not enter into the waterproof and breathable layer 24 so as to retain the cleanness of the interior of the pet cushions of the present invention. Furthermore in cleaning, it only needs to clean the outer cover. This causes the cleaning work to be easy and convenient.

Since the waterproof and breathable layer 24 has the effect of air ventilation, the cushion may retain in cleaning state.

The waterproof and air permeable layer 24 of the present invention causes that dirt and waste objects are confined on the cover 20. In cleaning, it only needs to detach the cover 20 from the cushion and then to clean the cover 20 singly. The operation is convenient and easily.

In the present invention, the outer cover 20 is a two layer object containing the surface cloth layer 22 and the waterproof and breathable layer 24. Furthermore the surface cloth layer 22 provides a preferred touch feeling so as to have both the effects of protection and comfortability.

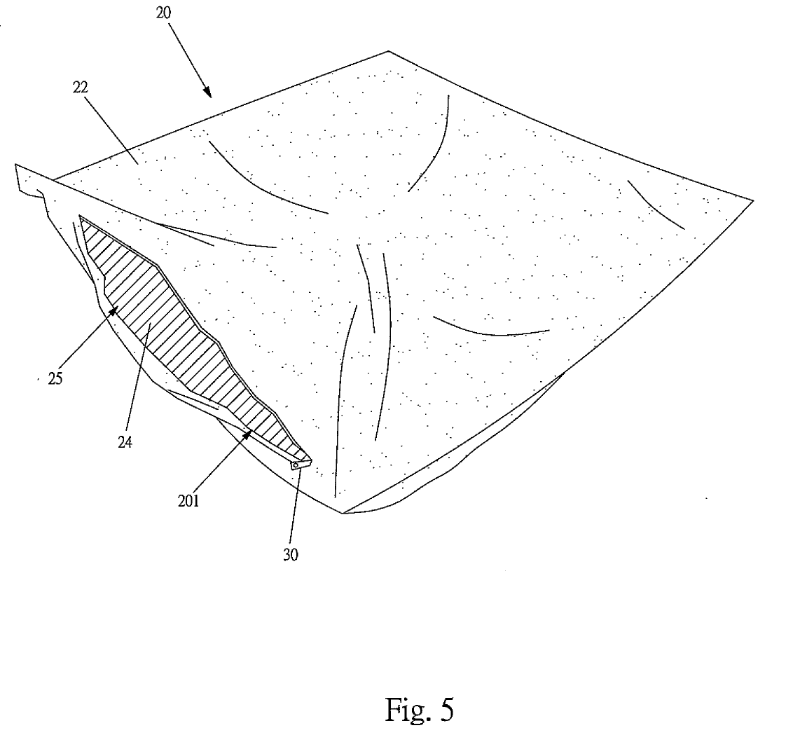

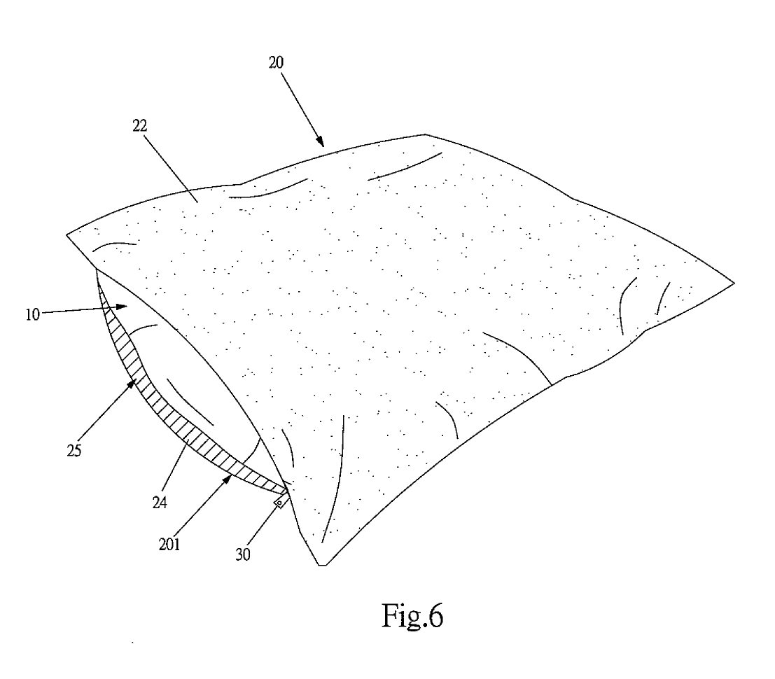

In the present invention, the outer cover 20 is formed with a cover opening 201 so that interior of the outer cover 20 is formed as a cavity (referring to FIG. 5). The core 10 is placed into the cavity 24 from the opening 201 (referring to FIG. 6)

A cover opening 201 of the outer cover 20 has an opening and closing structure 30 for opening or closing the cover opening 201 (referring to FIG. 5). The structure 30 may be a zipper, a touch fastener, a buckle, a button, etc. Referring to FIG. 6, the core 10 can be taken out from the cover opening 201 of the cover 20 by opening the opening and closing structure 30.

The cushion of the present invention is especially suitable for pets which are bad in sanitation, while the conventional pet cushions have no functions of waterproof, breathability, fireproof, anti-mite, anti-mildew and other functions, but the cushions of the present invention provides such functions.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A waterproof and breathable pet cushion, comprising:
a core containing filler;
an outer cover covering outer sides of the core; the outer cover containing a surface cloth layer and a waterproof and breathable layer at an inner side of the surface cloth layer; the waterproof and breathable layer being made of polyurethane;
wherein the waterproof and breathable layer has the advantages of waterproof, breathability, burn-proof, insects-proof; as a result, the dirt of pets or fluid will not enter into the waterproof and breathable layer so as to retain the cleanness of an interior of the pet cushions; and in cleaning, it only needs to clean the outer cover.

2. The waterproof and breathable pet cushion as claimed in claim 1, wherein the waterproof and breathable layer is adhered to an inner side of the surface cloth layer by gluing or adhesive materials.

3. The waterproof and breathable pet cushion as claimed in claim 1, wherein material of filler is soft.

4. The waterproof and breathable pet cushion as claimed in claim 1, wherein the filler is selected from one of cotton, sponge, cloth, plant filling materials, petals, straws, and activated carbons.

5. The waterproof and breathable pet cushion as claimed in claim 1, wherein the surface cloth layer is made of polyester fiber.

6. The waterproof and breathable pet cushion as claimed in claim 1, wherein the outer cover is formed with an outer opening so that the interior of the outer cover is formed with a cavity for receiving the core.

7. The waterproof and breathable pet cushion as claimed in claim 6, wherein the opening of the outer cover has an opening and closing structure for opening or closing the opening of the outer cover.

8. The waterproof and breathable pet cushion as claimed in claim 7, wherein the opening and closing structure is selected from a zipper, a touch fastener, a buckle, and a button.

9. The waterproof and breathable pet cushion as claimed in claim 1, wherein the cover further contains an inner cover for covering the filler.
